(19) United States
(12) Patent Application Publication
(10) Pub. No.: US 2011/0184694 A1
(43) Pub. Date: Jul. 28, 2011

(54) DEPTH MEASUREMENTS OF NARROW HOLES

(75) Inventors: Ilana Grimberg, Haifa (IL); Michael Bloomhill, Kfar-Tavor (IL); Shimon Koren, Haifa (IL)

(73) Assignee: CAMTEK LTD., Migdal Haemek (IL)

(21) Appl. No.: 12/673,775

(22) PCT Filed: Aug. 18, 2008
(86) PCT No.: PCT/IL08/01136

§ 371 Date: Apr. 12, 2011

Related U.S. Application Data
(60) Provisional application No. 60/956,699, filed on Aug. 19, 2007.

(51) Int. Cl. G01B 11/22

(52) U.S. Cl. 702/166

(57) ABSTRACT

A method for measuring a depth of a narrow hole, the method includes: obtaining from a chromatic confocal sensor a group of height measurements taken along an imaginary line that crosses the narrow hole; ignoring height measurements attributed to optical artifacts and blind measurement points and calculating an inverted parabolic estimate of a sub-group of the height measurements; wherein a top of the parabolic estimate is representative of a height of a bottom of the narrow hole.

### RELATED APPLICATIONS

This application claims the priority of U.S. provisional patent Ser. No. 60/956,699, filing date 19, Aug. 2007.

### BACKGROUND OF THE INVENTION

Through-silicon via (TSV) process connects thinned wafers together by etching thousands of holes through each layer and filling them with metal to create a three dimensional integrated stacked chip. This technology possess many advantages compared with alternative technologies, such as system-in-a-package and system-on-a chip. TSV offer greater density in the same footprint, as well as improved functionality, higher performance, lower power consumption, lower cost, greater manufacturing flexibility and faster time to market. Compared with two dimensional chips, three dimensional TSV chips conveniently eliminate the need for wire bonding and reduce the distance information on a chip needs to travel by a whopping by a factor of a thousand.

TSV also allows the addition of up to one hundred times more channels or pathways for that information to flow. In addition to TSV technology, depth measurement of trenches and holes in various MEMS applications is crucial for process control and correct mode of operation.

Conventional cross-section scanning electron microscopy is a destructive method and requires enormous handling and sample preparation. It can be performed only as a sampling mode. Focused ion beam cannot be employed because of the large depth of the holes. There is a need to provide non-destructive and reliable measurements methods for these applications.

Non destructive measurements of different objects with small diameter (smaller than one hundred micron) and aspect ratio (depth to diameter ration) larger than 2:1 presents a challenge. One technology which may be utilized for this purpose is confocal microscopy. The basic principle of confocal microscopy is described in U.S. Pat. No. 3,013,467 of Minsky. The principle of operation of chromatic confocal systems is illustrated in U.S. patent application publication serial number 2005/0030528 of Geffen et al.

Chromatic Confocal sensor (CCS) modules are best suited to measure flat reflective surfaces. Curved and or rigid surfaces introduce errors to the CCS measurement. These measurements are not statistical in nature and can not be filtered out by applying statistical methods such as averaging. These errors include blind measurement spots and optical artifacts. Blind optical points are characterized by very weak detection signals that can be interpreted as very low depths. The optical artifacts can be represented by strong peaks.

The amount of information (number of height measurement) obtained from a single TSV is relatively small and can affect the quality of height estimation. Filtering out height measurements can reduce the accuracy of the height estimation.

There is a need to provide an accurate and CCS based height measurement method and system.

### SUMMARY OF THE INVENTION

A method for measuring a depth of a narrow hole, the method includes: obtaining from a chromatic confocal sensor a group of height measurements taken along an imaginary line that crosses the narrow hole; ignoring height measurements attributed to optical artifacts and blind measurement points and calculating an inverted parabolic estimate of a sub-group of the height measurements; wherein a top of the parabolic estimate is representative of a height of a bottom of the narrow hole.

The method can include performing multiple iterations of the calculating of the inverted parabolic estimate; wherein each iteration comprises selecting a current sub-group of height measurements that affect a current inverted parabolic estimate in response to a previous inverted parabolic estimate.

The method comprising repeating the stages of: calculating an inverted parabolic estimate in response to the sub-group of the height measurements; performing a residual analysis of the group of height measurements in relation to the inverted parabolic estimate; selecting a sub-group of points in response to the residual analysis; and jumping to the stage of calculating.

The method can include repeating the stages of: calculating an inverted parabolic estimate in response to the sub-group of the height measurements; performing a residual analysis of the group of height measurements in relation to the inverted parabolic estimate; selecting a sub-group of points in response to the residual analysis; and jumping to the stage of calculating until an inverted parabolic estimate fulfills an accuracy condition.

The method can include ignoring height measurements of a certain value of the number of height measurements that have that certain value that is below a threshold.

The method can include obtaining from a chromatic confocal sensor multiple groups of height measurements, different groups of height measurements are taken along different imaginary lines that cross the narrow hole; and repeating the stages of ignoring and calculating for each group of height measurements to provide multiple depth estimations of the narrow hole.

The method can include obtaining, by an optical microscope, images of an area that comprises multiple narrow holes and a surface of a layer through which the narrow holes are formed.

The method can include obtaining from a chromatic confocal sensor height measurements taken from an area that comprises a surface of a layer and multiple narrow holes that are formed in the layer and determining a height of the surface.

The method can include creating a histogram of the group of height measurements and discarding height measurements of values outside an expected height measurement range.

A system for measuring a depth of a narrow hole, the system comprising: a chromatic confocal sensor adapted to obtain a group of height measurements taken along an imaginary line that crosses the narrow hole; a processor adapted to ignore height measurements attributed to optical artifacts and blind measurement points and calculate an inverted parabolic estimate of a sub-group of the height measurements; wherein a top of the parabolic estimate is representative of a height of a bottom of the narrow hole.

The processor can be adapted to perform multiple iterations of the calculating of the inverted parabolic estimate; wherein each iteration comprises selecting a current sub-group of height measurements that affect a current inverted parabolic estimate in response to a previous inverted parabolic estimate.

The processor can be adapted to repeat the stages of: calculating an inverted parabolic estimate in response to the sub-group of the height measurements; performing a residual analysis of the group of height measurements in relation to the inverted parabolic estimate; selecting a sub-group of points in response to the residual analysis; and jumping to the stage of calculating.

The processor can be adapted to repeat the stages of: calculating an inverted parabolic estimate in response to the sub-group of the height measurements; performing a residual analysis of the group of height measurements in relation to the inverted parabolic estimate; selecting a sub-group of points in response to the residual analysis; and jumping to the stage of calculating until an inverted parabolic estimate fulfills an accuracy condition.

The processor can be adapted to ignore height measurements of a certain value of the number of height measurements that have that certain value that is below a threshold.

The chromatic confocal sensor can be adapted to obtain from a chromatic confocal sensor multiple groups of height measurements, different groups of height measurements are taken along different imaginary lines that cross the narrow hole; and the processor can be adapted to repeat the stages of ignoring and calculating for each group of height measurements to provide multiple depth estimations of the narrow hole.

The chromatic confocal sensor can be adapted to obtaining, by an optical microscope, images of an area that comprises multiple narrow holes and a surface of a layer through which the narrow holes are formed.

The chromatic confocal sensor can be adapted to obtain height measurements taken from an area that comprises a surface of a layer and multiple narrow holes that are formed in the layer and determining a height of the surface.

The processor can be adapted to create a histogram of the group of height measurements and discarding height measurements of values outside an expected height measurement range.

A computer program product that includes a computer readable medium that stores instructions for: obtaining from a chromatic confocal sensor a group of height measurements taken along an imaginary line that crosses the narrow hole; ignoring height measurements attributed to optical artifacts and blind measurement points and calculating an inverted parabolic estimate of a sub-group of the height measurements; wherein a top of the parabolic estimate is representative of a height of a bottom of the narrow hole.

The computer program product can include instructions for performing multiple iterations of the calculating of the inverted parabolic estimate; wherein each iteration comprises selecting a current sub-group of height measurements that affect a current inverted parabolic estimate in response to a previous inverted parabolic estimate.

The computer program product can include instructions for repeating the stages of: calculating an inverted parabolic estimate in response to the sub-group of the height measurements; performing a residual analysis of the group of height measurements in relation to the inverted parabolic estimate; selecting a sub-group of points in response to the residual analysis; and jumping to the stage of calculating.

The computer program product can include instructions for repeating the stages of: calculating an inverted parabolic estimate in response to the sub-group of the height measurements; performing a residual analysis of the group of height measurements in relation to the inverted parabolic estimate; selecting a sub-group of points in response to the residual analysis; and jumping to the stage of calculating until an inverted parabolic estimate fulfills an accuracy condition.

The computer program product can include instructions for ignoring height measurements of a certain value of the number of height measurements that have that certain value is below a threshold.

The computer program product can include instructions for: obtaining from a chromatic confocal sensor multiple groups of height measurements, different groups of height-measurements are taken along different imaginary lines that cross the narrow hole; and repeating the stages of ignoring and calculating for each group of height measurements to provide multiple depth estimations of the narrow hole.

The computer program product can include instructions for obtaining, by an optical microscope, images of an area that comprises multiple narrow holes and a surface of a layer through which the narrow holes are formed.

The computer program product can include instructions for obtaining from a chromatic confocal sensor height measurements taken from an area that comprises a surface of a layer and multiple narrow holes that are formed in the layer and determining a height of the surface.

The computer program product can include instructions for creating a histogram of the group of height measurements and discarding height measurements of values outside an expected height measurement range.

### BRIEF DESCRIPTION OF THE INVENTION

The present invention will be understood and appreciated more fully from the following detailed description taken in conjunction with the drawings in which:

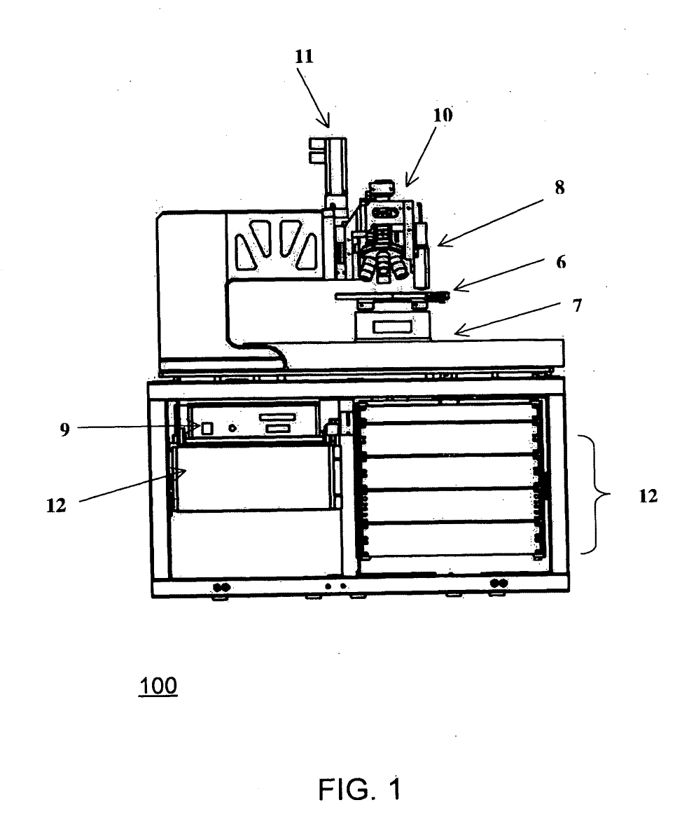

FIG. 1 illustrates a systems according to an embodiment of the invention;

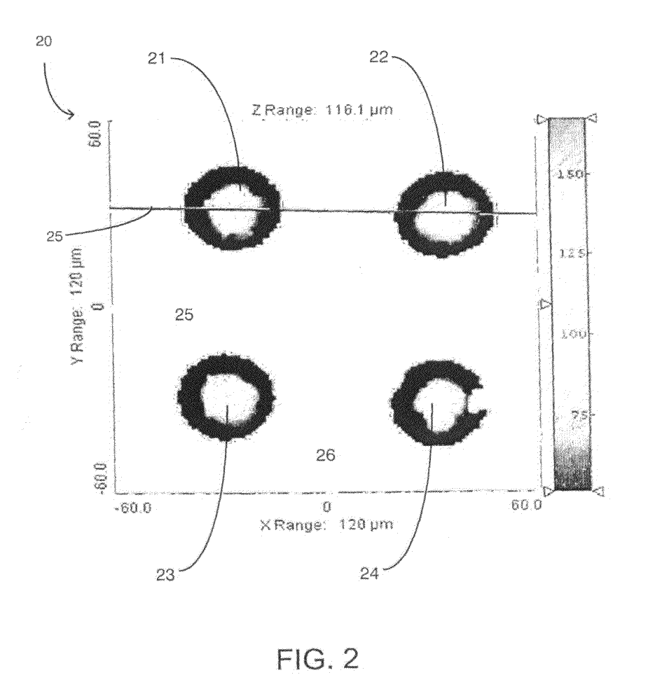

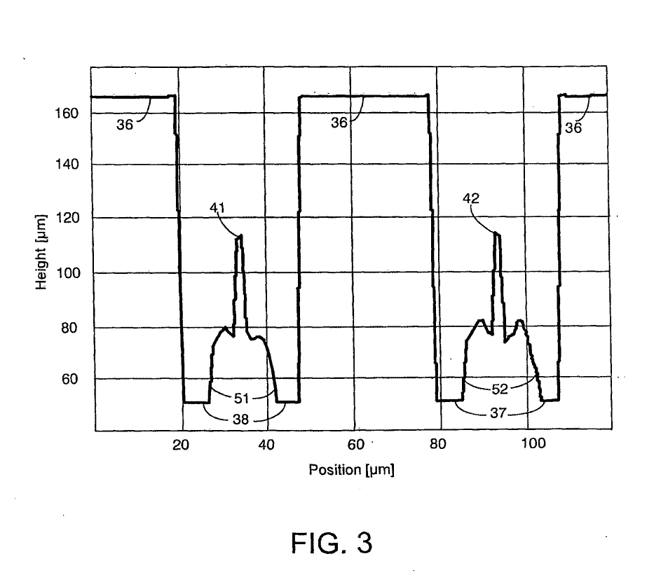

FIG. 2 is a top view of height measurements obtained from CCS module of a rectangular area that includes four narrow holes while FIG. 3 illustrates a group of height measurements that were taken along an imaginary line that crosses two narrow holes, according to an embodiment of the invention;

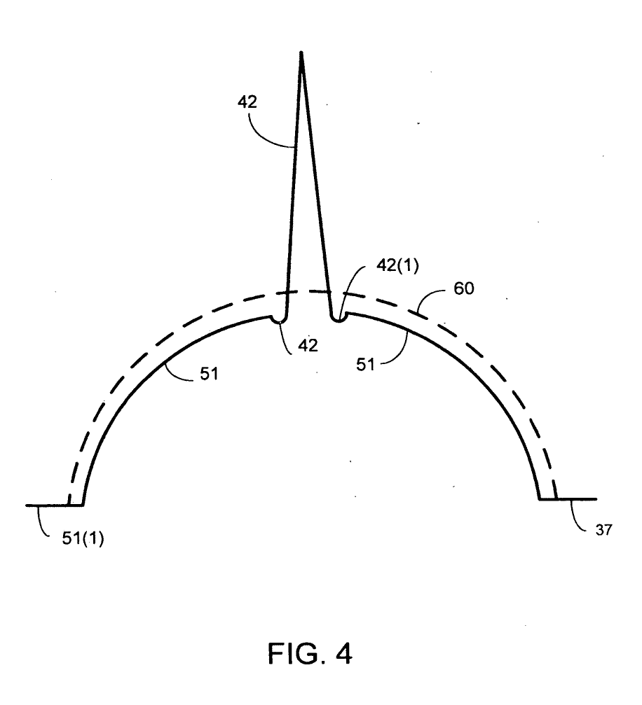

FIG. 4 illustrates an inverted parabolic estimate of measurement signals, as well as various height measurements according to an embodiment of the invention; and

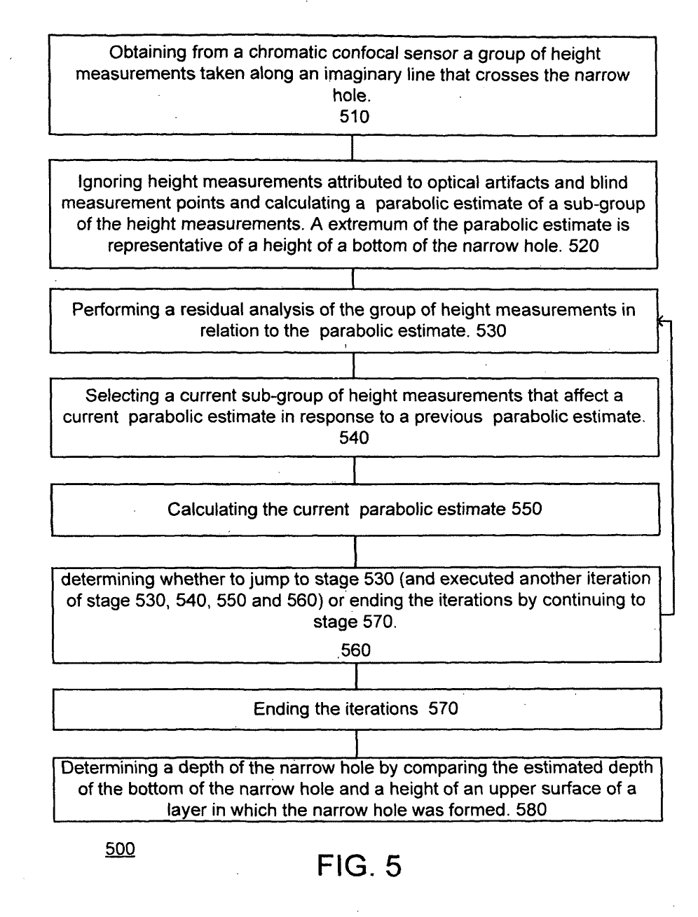

FIG. 5 illustrates a method according to an embodiment of the invention.

### DETAILED DESCRIPTION OF THE INVENTION

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

In the following specification, the invention will be described with reference to specific examples of embodiments of the invention. It will, however, be evident that various modifications and changes may be made therein without departing from the broader spirit and scope of the invention as set forth in the appended claims.

The mentioned below system and method measure a depth of a narrow hole. The narrow hole can be a TSV but this is not necessarily so.

FIG. 1 illustrates system 100 according to an embodiment of the invention. System 10 includes: (i) table 6 that supports an inspected object (such as a TSV wafer), (ii) XY axis translation module 7, (iii) CCS module that includes controller 9, optical pen 8 and a cable (not shown) connecting between controller 9 and optical pen, wherein optical pen 8 is positioned perpendicular to table 6, (iv) optical microscope 10, (v) z axis translation module 11, and (vi) computers 12.

It is noted that system 100 can include more than a single sensor—more than a single optical pen. These multiple optical pens can be connected to a turret that can enable replacement of the optical pen that performs the height measurement. Optical microscope 10 can be integrated with cameras (such as black and white cameras or color cameras) for wafer inspection and verification. Optical microscope 10 can be positioned perpendicular to table 6 but this is not necessarily so.

Conveniently, optical microscope 10 and optical pen 8 are aimed to the same point in the XY plane.

Z axis translation module 11 can elevate or lower optical microscope 10 and optical pen 8 so that each of them will reach its focal depth of field, but this is not necessarily so.

Computers 12 can perform at least one of the following tasks or a combination thereof: (i) control translation modules 7 and 11, (ii) enable job formation, (iii) create wafer map, (iv) perform two dimension inspection analysis, and (v) perform depth measurement.

System 100 can perform two-dimensional and three-dimensional metrology of different objects. The CCS module can participate in the depth measurement, especially of narrow holes such as TSVs.

System 100 can perform various measurements by performing a first stage of wafer handling, a second stage of setup and job creation, a third stage of two dimensional measurement and a fourth stage of CCS base height measurement.

The first stage of wafer handling includes placing a wafer on table 7 and is aligned before starting the inspection and measurements. After a measurement the wafer ends the wafer is unloaded to a wafer cassette.

The second stage of setup and job creation includes creating, by optical microscope 10, an image of one or more dice of the wafer, calculates dice indexes, and crates a wafer map that shows the dies layout related to a certain job.

The third stage of two dimensional inspection includes wafer scanning at a defined magnification using the optical microscope, reflective or dark field illumination or a combination of both, and optionally obtaining (and even displaying) images obtained by black and white and/or and color cameras. This stage can also include height measurements that do not involve the CCS module.

The fourth stage of CCS based depth measurements can include selecting the narrow holes (or other elements) to be measured. The selection can be done by a user or by an automatic process. For example, suspected defective narrow holes can be measured. The depth of each selected narrow hole is measured by performing both deterministic and iterating approach. It can include a first phase of statistical signal segmentation and a second phase of iterative calculations.

The statistical signal segmentation phase can include marking height measurements related to a parabolic estimate of the bottom of the narrow hole as “good”, while marking the height measurements that are suspected to represent optical artifact and blind detection points are marked as “bad” and are not taken into account when calculating an inverted parabolic estimate. The term “inverted” indicates that the peak of the estimation is the highest point of the estimate.

The second phase of iterative calculation includes performing an iterative loop of calculating an inverted parabolic estimate, performing a residual analysis, classifying height measurements in view of the residual analysis and repeating a calculation of the inverted parabolic estimate until a predefined condition (such as an inverse parabolic estimate that reaches a certain quality) is fulfilled. The quality can be evaluated by various methods including but not limited to means square error.

Each inverted parabolic estimate can be calculated by taking into account “good” height measurements and ignoring “bad” height measurements. The residual analysis can take into account all height measurement—both “bad” and “good” height measurements—perform a fit of all points marked as “good”. The residual analysis is followed by classifying the height measurements to “good” and “bad” based upon their distance from the inverted parabolic estimate. Height measurements that are distant from the inverted parabolic estimate (the distance between these height measurements and inverter parabolic estimate exceeds a predefined distance) can be marked as “bad”.

FIG. 2 is a top view of height measurements obtained from CCS module of a rectangular area 20 that include four narrow holes 21, 22, 23 and 24 while FIG. 3 illustrates a group of height measurements that were taken along imaginary line 25 that crosses narrow holes 21 and 22. Area 20 also includes upper surface 26 of a layer in which narrow holes 21-24 were formed.

FIG. 3 illustrates height measurements 36 obtained from upper surface 36, height measurements 37 and 38 that are attributed to blind detection points, height measurements 41 and 42 that are attributed to optical artifacts and height measurements 51 (of narrow hole 21) and 52 (of hole 22) that are attributed to the bottom of narrow holes 21 and 22.

It is assumed that height measurements 51 and 52 are noisy and that they can be estimated by providing an inverted parabolic estimate that has a top that represents the height of the bottom of a narrow hole. The depth of each narrow hole is the difference between the height of upper surface 26 and the height of the bottom of the narrow hole.

FIG. 4 illustrates an inverted parabolic estimate 60 of height measurements 51, as well as various height measurements 42 and 37 that were ignored.

After applying a residual analysis, height measurements such as height measurement 51(1) can be ignored and height measurements such as height measurement 42(1) can be taken into account when calculating the next inverted parabolic estimate.

FIG. 5 illustrates method 500 according to an embodiment of the invention.

Method 500 starts by stage 510 of obtaining from a chromatic confocal sensor a group of height measurements taken along an imaginary line that crosses the narrow hole.

Stage 510 is followed by stage 520 of ignoring height measurements attributed to optical artifacts and blind measurement points and calculating an inverted parabolic estimate of a sub-group of the height measurements. A top of the parabolic estimate is representative of a height of a bottom of the narrow hole.

Stage 520 can include calculating a histogram of the group of height measurements and discarding height measurements of values outside an expected height measurement range.

Stage 520 an include ignoring height measurements of a certain value of the number of height measurements that have that certain value is below a threshold. These height measurements can be attributed to noise or other measurement errors.

Stage 520 is followed by stage 530 of performing a residual analysis of the group of height measurements in relation to the inverted parabolic estimate.

Stage 530 is followed by stage 540 of selecting a current sub-group of height measurements that affect a current inverted parabolic estimate in response to a previous inverted parabolic estimate. During a first iteration of stage 540 the previous inverter parabolic estimate is the estimate calculated during stage 530.

Stage 540 is followed by stage 550 of calculating the current inverted parabolic estimate.

Stage 550 is followed by stage 560 of determining whether to jump to stage 530 (and executed another iteration of stage 530, 540, 550 and 560) or ending the iterations by continuing to stage 570. The determining of stage 560 can include determining whether the inverter parabolic estimate reaches a certain quality level. The determining can be responsive to the number of iterations.

Stage 570 is followed by stage 580 of determining a depth of the narrow hole by comparing the estimated depth of the bottom of the narrow hole and a height of an upper surface of a layer in which the narrow hole was formed.

Method 500 can be repeated multiple times and be applied on height measurements taken from different imaginary lines that cross the narrow holes. These repetitions can assist in determining multiple points of the bottom of a narrow hole. These repetitions can assist in generating a three-dimensional map of a narrow hole.

Accordingly, the repetitions of method 500 can include: (i) obtaining from a chromatic confocal sensor multiple groups of height measurements, different groups of height measurements that are taken along different imaginary lines that cross the narrow hole; (ii) repeating the stages of selecting measurement points, and calculating an inverted parabolic estimate for each group of height measurements to provide multiple depth estimations of the narrow hole.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations, and alternatives are also possible. The specifications and drawings are, accordingly, to be regarded in an illustrative rather than in a restrictive sense.

The word “comprising” does not exclude the presence of other elements or steps then those listed in a claim. It is understood that the terms so used are interchangeable under appropriate circumstances such that the embodiments of the invention described herein are, for example, capable of operation in other orientations than those illustrated or otherwise described herein.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe.

Thus, these terms are not necessarily intended to indicate temporal or other prioritization of such elements. The mere fact that certain measures are recited in mutually different claims does not indicate that a combination of these measures cannot be used to advantage.

What is claimed is:

1. A method for measuring a depth of a narrow hole, the method comprising:
obtaining from a chromatic confocal sensor a group of height measurements taken along an imaginary line that crosses the narrow hole;
ignoring height measurements attributed to optical artifacts and blind measurement points and calculating an inverted parabolic estimate of a sub-group of the height measurements;
wherein a top of the parabolic estimate is representative of a height of a bottom of the narrow hole.

2. The method according to claim 1 comprising performing multiple iterations of the calculating of the inverted parabolic estimate; wherein each iteration comprises selecting a current sub-group of height measurements that affect a current inverted parabolic estimate in response to a previous inverted parabolic estimate.

3. The method according to claim 1 comprising repeating the stages of:
calculating an inverted parabolic estimate in response to the sub-group of the height measurements;
performing a residual analysis of the group of height measurements in relation to the inverted parabolic estimate;
selecting a sub-group of points in response to the residual analysis; and
jumping to the stage of calculating.

4. The method according to claim 1 comprising repeating the stages of:
calculating an inverted parabolic estimate in response to the sub-group of the height measurements;
performing a residual analysis of the group of height measurements in relation to the inverted parabolic estimate;
selecting a sub-group of points in response to the residual analysis; and
jumping to the stage of calculating until an inverted parabolic estimate fulfills an accuracy condition.

5. The method according to claim 1 comprising ignoring height measurements of a certain value of the number of height measurements that have that certain value is below a threshold.

6. The method according to claim 1 comprising:
obtaining from a chromatic confocal sensor multiple groups of height measurements, different groups of height measurements are taken along different imaginary lines that cross the narrow hole; and
repeating the stages of ignoring and calculating for each group of height measurements to provide multiple depth estimations of the narrow hole.

7. The method according to claim 1 comprising obtaining, by an optical microscope, images of an area that comprises multiple narrow holes and a surface of a layer through which the narrow holes are formed.

8. The method according to claim 1 comprising obtaining from a chromatic confocal sensor height measurements taken from an area that comprises a surface of a layer and multiple narrow holes that are formed in the layer and determining a height of the surface.

9. The method according to claim 1 comprising creating a histogram of the group of height measurements and discarding height measurements of values outside an expected height measurement range.

10. A system for measuring a depth of a narrow hole, the system comprising:
a chromatic confocal sensor adapted to obtain a group of height measurements taken along an imaginary line that crosses the narrow hole;
a processor adapted to ignore height measurements attributed to optical artifacts and blind measurement points and calculate an inverted parabolic estimate of a sub-group of the height measurements; wherein a top of the parabolic estimate is representative of a height of a bottom of the narrow hole.

11. The system according to claim 10 wherein the processor is adapted to perform multiple iterations of the calculating of the inverted parabolic estimate; wherein each iteration comprises selecting a current sub-group of height measurements that affect a current inverted parabolic estimate in response to a previous inverted parabolic estimate.

12. The system according to claim 10 wherein the processor is adapted to repeat the stages of:
calculating an inverted parabolic estimate in response to the sub-group of the height measurements;
performing a residual analysis of the group of height measurements in relation to the inverted parabolic estimate;
selecting a sub-group of points in response to the residual analysis; and
jumping to the stage of calculating.

13. The system according to claim 10 wherein the processor is adapted to repeat the stages of:
calculating an inverted parabolic estimate in response to the sub-group of the height measurements;
performing a residual analysis of the group of height measurements in relation to the inverted parabolic estimate;
selecting a sub-group of points in response to the residual analysis; and
jumping to the stage of calculating until an inverted parabolic estimate fulfills an accuracy condition.

14. The system according to claim 10 wherein the processor is adapted to ignore height measurements of a certain value of the number of height measurements that have that certain value is below a threshold.

15. The system according to claim 10 wherein the chromatic confocal sensor is adapted to obtain from a chromatic confocal sensor multiple groups of height measurements, different groups of height measurements are taken along different imaginary lines that cross the narrow hole; and wherein the processor is adapted to repeat the stages of ignoring and calculating for each group of height measurements to provide multiple depth estimations of the narrow hole.

16. The system according to claim 10 wherein the chromatic confocal sensor is adapted to obtaining, by an optical microscope, images of an area that comprises multiple narrow holes and a surface of a layer through which the narrow holes are formed.

17. The system according to claim 10 wherein the chromatic confocal sensor is adapted to obtain height measurements taken from an area that comprises a surface of a layer and multiple narrow holes that are formed in the layer and determining a height of the surface.

18. The system according to claim 10 wherein the processor is adapted to create a histogram of the group of height measurements and discarding height measurements of values outside an expected height measurement range.

19. A computer program product that comprises a computer readable medium that stores instructions for:
obtaining from a chromatic confocal sensor a group of height measurements taken along an imaginary line that crosses the narrow hole;
ignoring height measurements attributed to optical artifacts and blind measurement points and calculating an inverted parabolic estimate of a sub-group of the height measurements;
wherein a top of the parabolic estimate is representative of a height of a bottom of the narrow hole.

20. The computer program product according to claim 19 comprising instructions for performing multiple iterations of the calculating of the inverted parabolic estimate; wherein each iteration comprises selecting a current sub-group of height measurements that affect a current inverted parabolic estimate in response to a previous inverted parabolic estimate.

21. The computer program product according to claim 19 comprising instructions for repeating the stages of:
calculating an inverted parabolic estimate in response to the sub-group of the height measurements;
performing a residual analysis of the group of height measurements in relation to the inverted parabolic estimate;
selecting a sub-group of points in response to the residual analysis; and
jumping to the stage of calculating.

22. The computer program product according to claim 19 comprising instructions for repeating the stages of:
calculating an inverted parabolic estimate in response to the sub-group of the height measurements;
performing a residual analysis of the group of height measurements in relation to the inverted parabolic estimate;
selecting a sub-group of points in response to the residual analysis; and
jumping to the stage of calculating until an inverted parabolic estimate fulfills an accuracy condition.

23. The computer program product according to claim 19 comprising instructions for ignoring height measurements of a certain value of the number of height measurements that have that certain value is below a threshold.

24. The computer program product according to claim 19 comprising instructions for:
obtaining from a chromatic confocal sensor multiple groups of height measurements, different groups of height measurements are taken along different imaginary lines that cross the narrow hole; and
repeating the stages of ignoring and calculating for each group of height measurements to provide multiple depth estimations of the narrow hole.

25. The computer program product according to claim 19 comprising instructions for obtaining, by an optical microscope, images of an area that comprises multiple narrow holes and a surface of a layer through which the narrow holes are formed.

26. The computer program product according to claim 19 comprising instructions for obtaining from a chromatic confocal sensor height measurements taken from an area that comprises a surface of a layer and multiple narrow holes that are formed in the layer and determining a height of the surface.

27. The computer program product according to claim 19 comprising instructions for creating a histogram of the group of height measurements and discarding height measurements of values outside an expected height measurement range.
